(19) United States
(12) Patent Application Publication
(10) Pub. No.: US 2012/0175438 A1
(43) Pub. Date: Jul. 12, 2012

(54) DEVICE THAT CAN MAKE PULSED WATER

(75) Inventors: Yangfeng Ji, Xiamen (CN); Jianmin Chen, Xiamen (CN); Liangwei Wang, Xiamen (CN); Huasong Zhou, Xiamen (CN)

(73) Assignees: XIAMEN SOLEX HIGH-TECH INDUSTRIES CO., LTD., Xiamen (CN); Huasong Zhou, Xiamen (CN)

(21) Appl. No.: 12/986,350

(22) Filed: Jan. 7, 2011

(51) Int. Cl. B05B 1/26

(52) U.S. Cl. 239/601

(57) ABSTRACT

The present invention provides a device that can make pulsed water, including a base 100 equipped with a waterway 200. The waterway 100 consists of an inlet 210, an outlet 230 and a spherical cavity 220 forming between the inlet 210 and the outlet 230. The diameter of the spherical cavity 220 is larger than the caliber of the inlet 210, or that of the outlet 230. Some water flowing from the inlet to the spherical cavity will disperse, and others flows directly downwards. Some water hits the inwall of the spherical cavity and then reflects back to be reflection water. The reflection water impacts other water to turn to the side flowing down along the wall of the outlet. Due to the unstability of effluent, the water stream is along one place, turning to another side the next moment. So that the water sprays as a periodic and circumferential pulsed water.

### FIELD OF THE INVENTION

The present invention relates to a device that can make pulsed water.

### BACKGROUND OF THE INVENTION

The device to make pulsed water nowadays consists of a base and a movable element situated inside, and the movable element can move comparatively about the base, making the outflowing water wiggly spraying out. The device adopts a base and a movable element inside working together, achieving the pulsed water. But the device has the disadvantages: firstly, the structure is complex, occupying large, materials much, high precision and high cost; secondly, the movable element is easy to wear, and the effluent is unstable.

### SUMMARY OF THE INVENTION

The present invention provides a device that can make pulsed water, which overcomes the disadvantages of the background technology.

The technology solution of the present invention to solve the problem above is:

A device that can make pulsed water includes a base 100 equipped with a waterway 200 insides, wherein the waterway 200 consists of an inlet 210, an outlet 230 and a spherical cavity 220 forming between the inlet 210 and the outlet 230, the diameter of the spherical cavity 220 is larger than the caliber of the inlet 210 or the outlet 230.

In a preferred embodiment, the caliber of the outlet 230 is lager than that of the inlet 210.

In a preferred embodiment, the caliber ratio of the inlet 210 and the outlet 230 ranges from 0.5:1 to 0.8:1.

In a preferred embodiment, the joint of the inlet 210 and the spherical cavity adopts arc transition.

In a preferred embodiment, the joint of the outlet 210 and the spherical cavity adopts arc transition.

In a preferred embodiment, the inlet 210 is columnform.

In a preferred embodiment, the outlet includes at least a conical section 231.

In a preferred embodiment, the cone angle of the conical section 231 ranges from 5 degree to 50 degree.

In a preferred embodiment:

The base 100 consists of an upper base 110 and a lower base 120;

The underside of the upper base 110 has a sunk-in upper hemisphere cavity 111, and the inlet 210 locates in the upper base 110 and links the upper hemisphere cavity 111 and the top of the upper base 110.

The top of the lower base 120 has a sunk-in lower hemisphere cavity 121, and the outlet 230 locates in the lower base 120 and links the lower hemisphere cavity 121 and the underside of the lower base 120.

The upper base 110 is fixed to the lower base 120, and the upper hemisphere cavity 111 and the lower hemisphere cavity 121 connect to each other face to face forming a spherical cavity 220.

In a preferred embodiment, the base 100 is equipped with aspirated channel 300, the outside situates on the outerface of the base 100, the inside situating on the spherical cavity 220.

The technology solution has some advantages below comparatively to the background technology:

Some water hits the inwall of the spherical cavity and then reflects back to be reflection water. The reflection water impacts other water to turn to the side flowing down along the wall of the outlet. Due to the unstable effluent, the waterflowing is along one place, turning to the side at the next time. So that the water spraying periodically impulses. It overcomes the disadvantages of the background technology, and has the effects of application below: a. the full water particles spraying have better massage effect and visual impact; b. without movable element, the structure is simple, and the cost is low; c. without wear, the device has long service life and the frequency of the waterflowing is stable.

2. the diameter of the outlet is larger than that of the inlet, so that the volume is small when water pressure down. When the pressure increases, the volume increases as well, the water

3. The joint of the inlet and the spherical cavity adopts arc transition, so that the waterflowing in the transition state will stick and delay, and the waterflowing will fan out when crushing to the spherical cavity. The joint of the outlet and the spherical cavity adopts arc transition, so that some waterflowing will discharge along the wall of the outlet with the work of the arc transition.

4. The kinetic energy of the water increase when effluent flows from the inlet to the spherical cavity, because the diameter of the inlet is small.

5. The cone angle of the conical section ranges from 5 degree to 50 degree, which makes the spray effect better.

6. The waterway is formed from the fixation of the upper base and the lower base, so that the manufacture is simple and the cost is low.

7. The device adopts an aspirated channel to adjust the frequency of the impulse and make the splash is soft but strong, which saves water.

### THE BELIEF DESCRIPTION OF THE DRAWINGS

Further description will be provided from the combination of the drawings and the embodiments.

FIG. 1 illustrates the three dimensional schematic of a preferred embodiment;

FIG. 2 illustrates the profile schematic of a preferred embodiment;

FIG. 3 illustrates the dividing of schematic of a preferred embodiment;

FIG. 4 illustrates the profile schematic of another preferred embodiment;

FIG. 5 illustrates the dividing of schematic of another preferred embodiment.

### DETAIL DESCRIPTION OF THE PREFERRED EMBODIMENTS

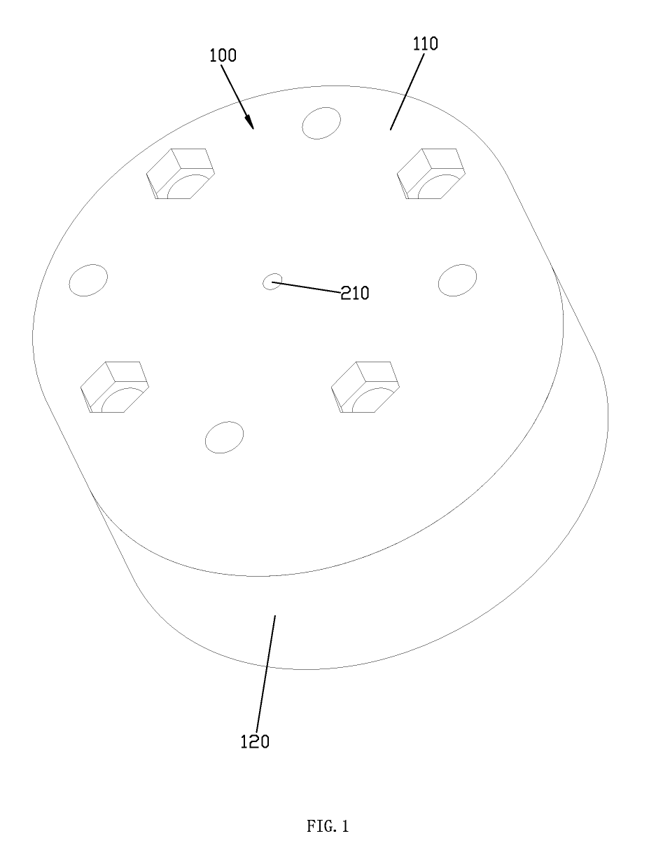

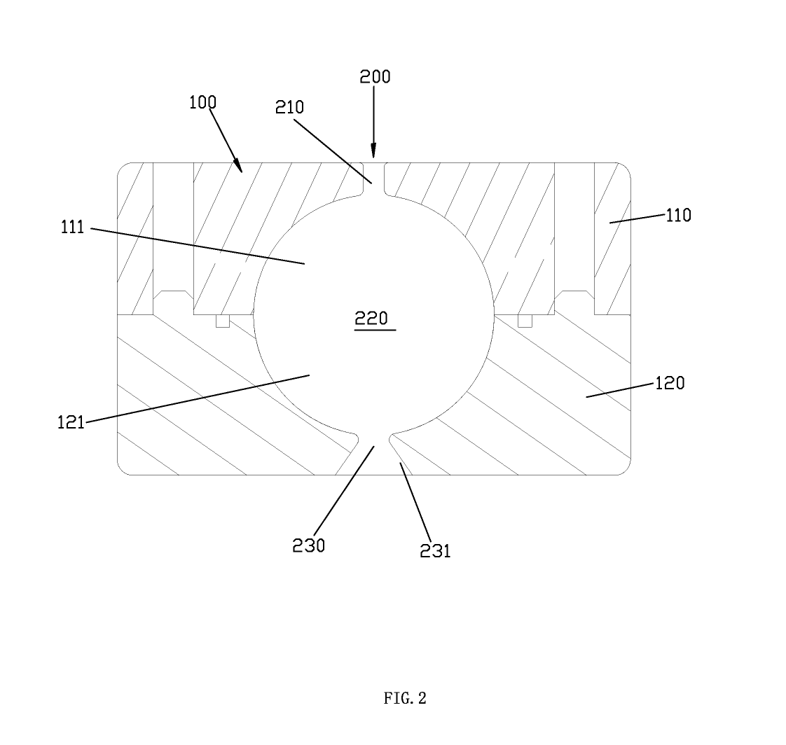

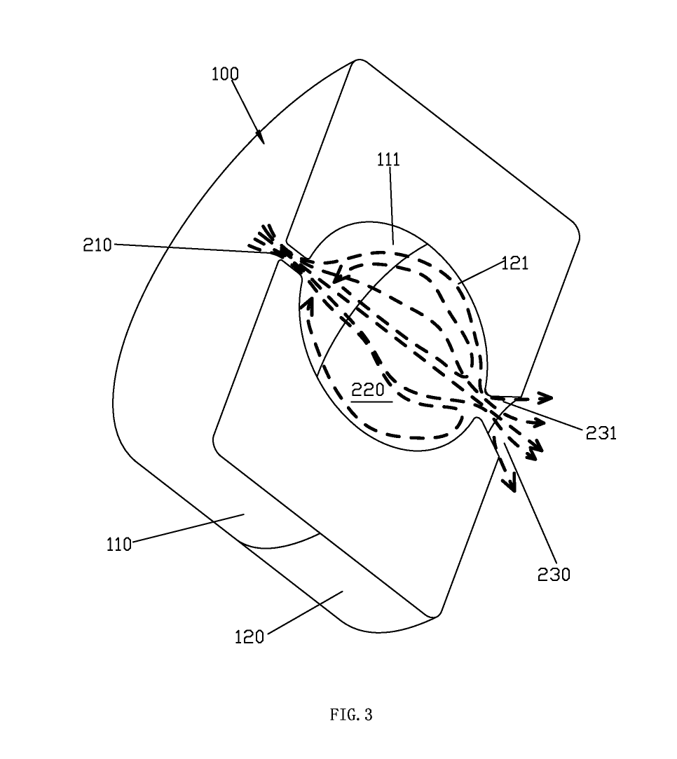

Referring to the FIG. 1, FIG. 2 and FIG. 3, a device that can make pulsed water comprises a base 100 equipped with a waterway 200 insides, wherein the waterway 200 consists of an inlet 210, an outlet 230 and a spherical cavity 220 forming between the inlet 210 and the outlet 230, the diameter of the spherical cavity 220 is larger than the caliber of the inlet 210 or the outlet 230.

The diameter of the spherical cavity 220 is larger than the caliber of the inlet 210 or the caliber of the outlet 230; the caliber of the outlet 230 is larger than that of the inlet 210; the caliber ratio of the inlet 210 and the outlet 230 ranges from 0.5:1 to 0.8:1, had better from 0.6:1 to 0.7:1.

It had better to be that: the joint of the inlet 210 and the spherical cavity 220 adopts arc transition; the joint of the outlet 230 and the spherical cavity 220 adopts arc transition.

It had better to be that: the inlet 210 is columnshape. The outlet 230 includes at least a conical section 231 with open end down. The cone angle of the conical section 231 ranges from 5 degree to 50 degree had better from 30 degree to 50 degree.

In this embodiment, the base 100 consists of an upper base 110 and a lower base 120; The underside of the upper base 110 has a sunk-in upper hemisphere cavity 111, and the inlet 210 locates in the upper base 110 and links the upper hemisphere cavity 111 and the top of the upper base 110. The top of the lower base 120 has a sunk-in lower hemisphere cavity 121, and the outlet 230 locates in the lower base 120 and links the lower hemisphere cavity 121 and the underside of the lower base 120. The upper base 110 is fixed to the lower base 120, and the upper hemisphere cavity is 111 and the lower hemisphere cavity 121 connect to each other face to face forming a spherical cavity 220.

Some water impacts the inwall of the spherical cavity and then reflects back to be reflection water. The reflection water impacts other water to turn to the side flowing down along the wall of the outlet. Due to the unstable effluent, the waterflowing is along one place, turning to the side at the next time. So that the water spraying periodically impulses.

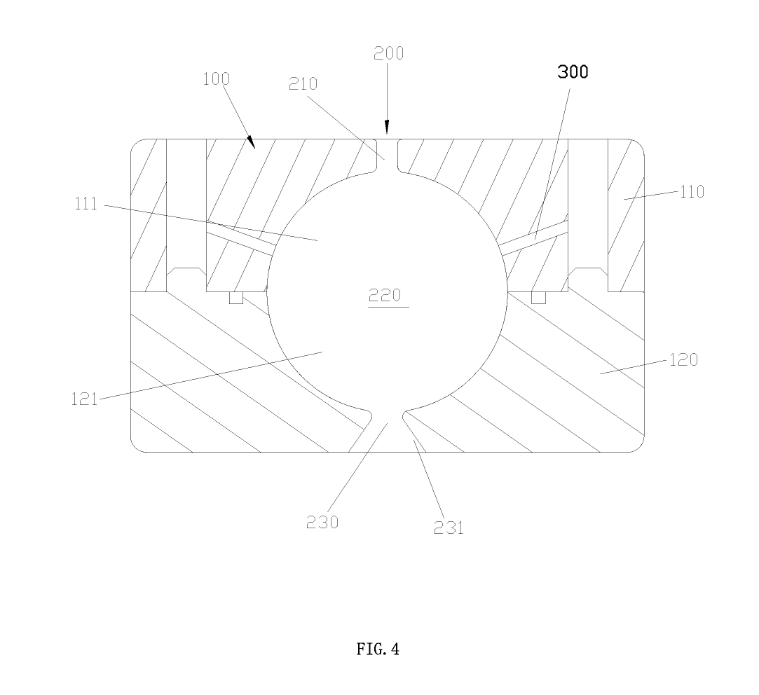

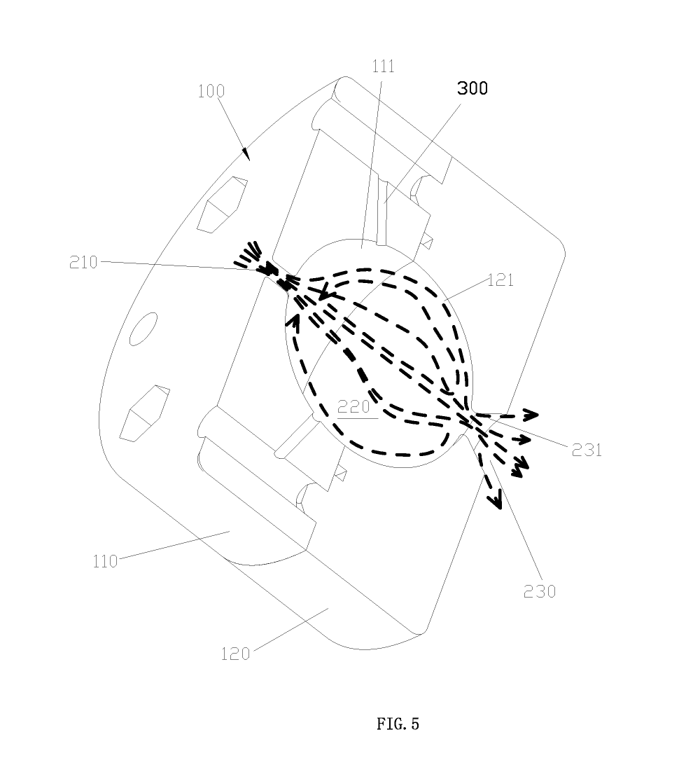

In another preferred embodiment, the way different form the embodiment above is: refer to the FIG. 4 and FIG. 5, the upper base 110 is equipped with an aspirated channel 300 which consists of a vertical hole opening from the top of the upper base 110 and an inclined via hole connecting the bottom of the vertical hole. The top of the vertical hole locates on the top of the upper base 110, and the inside port of the inclined via hole locates in the upper hemisphere cavity 111. The device adopts an aspirated channel to adjust the frequency of the impulse and make the splash is soft but strong, which saves water.

Although the present invention has been fully described by ways of preferred embodiments with reference to the accompanying drawings, it is to be noted that various changes and modifications will be apparent to those skilled in the art. Therefore, unless otherwise such changes and modifications depart from the scopes of the present invention, they is should be construed as being included therein.

What is claimed is:

1. A device that can make pulsed water includes a base 100 equipped with a waterway 200 insides, wherein the waterway 200 consists of an inlet 210, an outlet 230 and a spherical cavity 220 forming between the inlet 210 and the outlet 230, the diameter of the spherical cavity 220 is larger than the caliber of the inlet 210 or the outlet 230.

2. A device that can make pulsed water according to the claim 1, wherein the caliber of the outlet 230 is larger than that of the inlet 210.

3. A device that can make pulsed water according to the claim 2, wherein the caliber ratio of the inlet 210 and the outlet 230 ranges from 0.5:1 to 0.8:1.

4. A device that can make pulsed water according to the claim 1, wherein the joint of the inlet 210 and the spherical cavity 220 adopts arc transition.

5. A device that can make pulsed water according to the claim 1, wherein the joint of the outlet 230 and the spherical cavity 220 adopts arc transition.

6. A device that can make pulsed water according to the claim 1, wherein the inlet 210 is columniform.

7. A device that can make pulsed water according to the claim 1, wherein the outlet 230 includes at least a conical section 231.

8. A device that can make pulsed water according to the claim 7, wherein the cone angle of the conical section 231 ranges from 5 degree to 50 degree.

9. A device that can make pulsed water according to the claim 1, wherein:
The base 100 consists of an upper base 110 and a lower base 120;
The underside of the upper base 110 has a sunk-in upper hemisphere cavity 111, and the inlet 210 locates in the upper base 110 and links the upper hemisphere cavity 111 and the top of the upper base 110.
The top of the lower base 120 has a sunk-in lower hemisphere cavity 121, and the outlet 230 locates in the lower base 120 and links the lower hemisphere cavity 121 and the underside of the lower base 120.
The upper base 110 is fixed to the lower base 120, and the upper hemisphere cavity 111 and the lower hemisphere cavity 121 connect to each other face to face forming a spherical cavity 220.

10. A device that can make pulsed water according to the claim 1, wherein the base 100 is equipped with an aspirated channel 300, the outside situates on the outerface of the base 100, the inside situating on the spherical cavity 220.
